(19) United States
(12) Patent Application Publication
(10) Pub. No.: US 2015/0101057 A1
(43) Pub. Date: Apr. 9, 2015

(54) NETWORK SERVICE INTERFACE ANALYSIS

(71) Applicants: Eyal Fingold, Kfar-Saba (IL); Ben Feher, Ashod (IL); Gil Kedem, Bat Yam (IL)

(72) Inventors: Eyal Fingold, Kfar-Saba (IL); Ben Feher, Ashod (IL); Gil Kedem, Bat Yam (IL)

(21) Appl. No.: 14/381,437

(22) PCT Filed: Feb. 29, 2012
(86) PCT No.: PCT/US12/27115

§ 371 Date: Aug. 27, 2014

(51) Int. Cl. G06F 21/57

(52) U.S. Cl. CPC G06F 21/577; G06F 2221/034
USPC 726/25

(57) ABSTRACT

In one implementation, a service interface analysis system identifies a parameter at a portion of a service request for a network service and within a service response provided by the network service in response to the service request. The service interface analysis system then defines a request template including a placeholder at a portion of the request template associated with the portion of the service request.

### BACKGROUND

Security testing is used to assess a network service such as a web application for vulnerabilities or attack vectors. In one approach to security testing, a security testing application (or scanner) identifies the service interface of the network service (e.g., Uniform Resource Identifiers (URIs) such as Uniform Resource Locators (URLs) at which the application accepts input). The service interface of the network service is sometimes referred to as the attack surface of the network service.

The scanner identifies the service interface of the network service by analyzing web pages related to the network service to identify URIs referencing the network service, such as URIs that include a host identifier of the network service. In some implementations the scanner also provides Hypertext Transfer Protocol (HTTP) requests to and evaluates HTTP responses from the network service to determine whether the network service responds to requests at these URIs and characteristics of data returned in response to such requests.

The scanner then executes attacks based on the service interface such as HTTP requests directed to URIs at which the network service accepts input. These requests are particularly crafted to (e.g., have parameters or data payloads to) test for attack vectors such as memory buffer overflows, Structured Query Language (SQL) injection, privilege elevation, and arbitrary code execution, for example. Additionally, the scanner can diagnose the presence or absence of vulnerabilities by evaluating HTTP responses from the network service.

### BRIEF DESCRIPTION OF THE DRAWINGS

FIG. 1A is an illustration of an environment including a network service, according to an implementation.

FIGS. 1B-1D are illustrations of service requests and service responses, according to various implementations.

FIG. 2A is a flowchart of a service interface analysis process, according to an implementation.

FIGS. 2B and 2C are illustrations of request templates, according to different implementations.

FIG. 3 is data flow diagram illustrating operation of a service interface analysis system, according to an implementation.

FIG. 4 is an illustration of a service interface analysis process, according to another implementation.

FIG. 5 is a schematic block diagram of a service interface analysis system hosted at a computing system, according to an implementation.

### DETAILED DESCRIPTION

Some scanners perform security testing of a network service by first interpreting identified service requests for the service interface of the network service and altering parameters of those service requests to include attack data sets (e.g., data sets intended to test for attack vectors at a network service). For example, service requests such as HTTP requests with altered URIs can be provided to a network service to perform security testing of the network service.

The service interfaces of some network services lend themselves to such security testing. For example, a service interface can be based on service requests including URIs of the form: http://www.service.com/directory/file?name1=value1&name2=value2. This URI includes a host identifier “www.service.com”, a path to a file “/directory/file”, and a query string “name1=value1&name2=value2”. Typically, the query string is forwarded to and processed by the file identified by the path. Thus, the query string defines the inputs to the network service, or the service interface. Here, the network service accepts “value1” as an input parameter named “name1” and “value2” as an input parameter named “name2”.

A scanner can identify such service interfaces with relative ease because the URIs on the service requests defining such service interfaces conform to a pattern. More specifically, a resource (here, a file) is identified by a path from the host identifier of the network service, the query string is identified by a question mark character (“?”), each parameter name/value pair is separated from other parameter name/value pairs by an ampersand character (“&”), and the parameter name and value of any parameter name/value pair are separated by an equal sign character (“=”). By interpreting URIs according to this pattern, a scanner can identify the parameters (e.g., values of the name/value pairs) that can be altered to perform security testing of a network service.

The service interfaces of other network services, however, do not lend themselves to such security testing. For example, some network services expose or define a Representational State Transfer (REST) service interface. Service interfaces that conform to principles of REST (or network services that expose such service interfaces) are often referred to as “RESTful”. REST is not a protocol, but rather an architectural or interface style. One common trait of many RESTful service interfaces is that URIs for such service interface include parameters (or values of input parameters) as elements of a path of the URI, rather than, for example, as a query string within the URI.

For example, in contrast to the URI example from above (http://www.service.com/directory/file?name1=value1&name2=value2), a RESTful service interface can be based on service requests including URIs of any of the following forms: http://www.service.com/directory/file/value1/value2, http://www.service.com/value1/directory/file/value2, http://www.service.com/value2/directory/file/value1, or http://www.service.com/value1/value2/file.html. Such service interfaces are difficult for scanners to recognize because such URIs have a form similar to static URIs. That is, without a separate description of the service interface, the URI http://www.service.com/value1/value2/file.html can be interpreted to refer to a static web page titled “file.html” in a directory with the path “/value1/value2/” at a host identified by “www.service.com”, rather than as a URI including two parameters (i.e., “value1” and “value2”).

Moreover, such URIs do not conform to a clear pattern from which a scanner can identify parameters (or input parameter values) that can be altered to perform security testing of the network service. Furthermore, parameters that are provided to a network service within service requests can be located at portions of the service requests other than within URIs. For example, parameters that are provided to a network service within a service request can be included in a header portion, a body portion, or other portions of the service request. As a result, scanners are often unable to effectively perform security testing of network services with such service interfaces without assistance from test engineers with an understanding of the service interface of a network service on which the security testing will be performed.

Implementations discussed herein identify parameters within service requests that can be altered to perform security testing of a network service independent of a description of the service interface of the network service. More specifically, for example, implementations discussed herein identify such parameters within service requests by correlating parameters provided to a network service in service requests with information provided from the network service in service responses for those service requests. For example, a service interface analysis system can define a group of request templates (e.g., service requests or portions thereof in which elements of service requests that include or may include parameters are identified) based on service responses that include parameters provided in service request. The request templates can then be used to perform security testing of the network service.

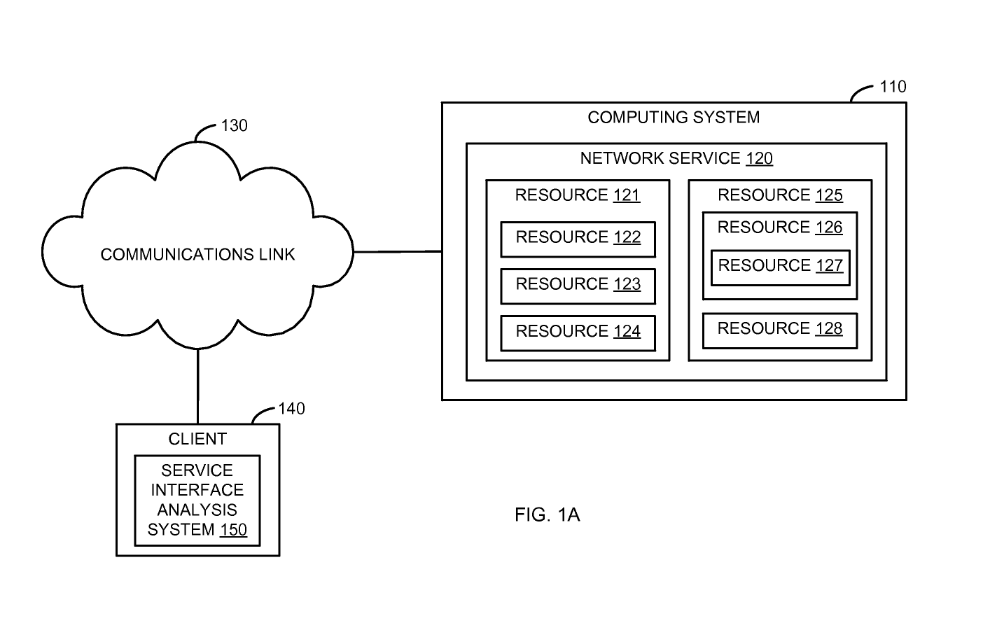

FIG. 1 is an illustration of an environment including a network service, according to an implementation. The environment shown in FIG. 1 is illustrated logically rather than physically. For example, components of the environment illustrated in FIG. 1 can include multiple physical components or a single physical component. As a specific example, computing system 110 can be a single computer server, an enclosure or rack of computer servers, a group of virtual machines hosted at a computer server or group of computer servers, or load balancer and a cluster of computer servers.

Client 140 is computing system such as a desktop computer, notebook or laptop computer, tablet device, or smartphone hosting an application such as a web or Internet browser or other application that accesses network service 120 via communications link 130. As illustrated in FIG. 1, client 140 also hosts service interface analysis system 150. As discussed in more detail herein, service interface analysis system 150 accesses service requests sent from client 140 to network service 120 and service responses received at client 140 from network service 120. For example, service interface analysis system 150 can be an agent application at client 140, and data (e.g., service requests and responses) sent to or received from communications link 130 can be provided to service interface analysis system 150 (e.g., by instrumenting an application or operating system at client 140). In some implementations, service interface analysis system 150 communicates with network service 120 via communications link 130. That is, interface analysis system 150 sends service requests to and receives service responses from network service 150. Thus, service interface analysis system 150 can access service requests and service responses because service interface analysis system 150 sends and receives, respectively, the service requests and service responses.

In other implementations, service interface analysis system 150 can be hosted at another computing device (not shown) in communication with communications link 130. For example, service interface analysis system 150 can be hosted at a proxy, router, switch, or other computing system within communications link 130, and can access service requests and service responses exchanged by client 140 and network service 120. As another example, service interface analysis system 150 can be hosted at a computing system in communication with communications link 130, and a proxy, router, switch, or other component within communications link 130 can be configured to provide service requests and service responses exchanged by client 140 and network service 120 to service interface analysis system 150.

Communications link 130 includes components such as devices, services, or combinations thereof that define communications paths between computing system 110, client 140, and/or other devices or services. For example, communications link 130 can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Communications link 130 can include communications networks such as an intranet, the Internet, other telecommunications networks, or a combination thereof. Additionally, communications link 130 can include proxies, routers, switches, gateways, bridges, load balancers, and similar communications devices. Furthermore, the connections and communications paths (e.g., between communications link 130 and client 140 and computing system 110) illustrated in FIG. 1 are logical and do not necessarily reflect physical connections.

Computing system 100 hosts network service 120. Network service 120 is an application or service such as web application via which resources can be accessed. Resources 121-128 are data or collections of data. For example, resource 121 can be a table within a relational database, and resources 121, 123, and 124 can be records within that relational database. Resource 125 can be, for example, a container (or collection) of images, resource 126 can be a container within resource 125, resource 127 can be an image within resource 126, and resource 128 can be an image within that resource 125.

Network service 120 defines a service interface via which resources 121-128 can be accessed, for example, by client 140. Said differently, the service interface of network service 120 defines a structure for service requests that identify resources 121-128 and/or operations that should be performed relative to resources 121-128 or other resources (not shown). A service request is a data set that identifies a resource and/or an operation to be performed relative to the resource. As a specific example, a service request can be an HTTP request such as a GET, POST, or PUT request.

Typically, a service request includes multiple portions at which parameters are provided to a network service. Parameters are data such as symbols, characters, or numbers that are provided within a service request as input to a network service. A parameter or a group of parameters can identify a resource, identify operations to be performed relative to a resource, represent data for operations to be performed relative to a resource (e.g., data used to update a resource), represent metadata related to a resource, or represent other data related to a resource.

Network service 120 receives service requests from client 140, and provides service responses to client 140 in response to the service requests. A service response includes information responsive to the service request such as a representation of a resource, metadata related to a resource, status information for an operation relative to a resource, metadata related to a network service, or other information.

For example, if a service request (or a related operation) failed at network service 120 or was improperly formatted (e.g., did not conform to the service interface of network service 120), the corresponding service request can include status information that indicates a failure occurred and/or a description of the of the failure. As another example, client 140 can provide to network service 120 a service request identifying resource 128 (e.g., an image) and requesting that resource 128 (or a representation of resource 128) be provided to client 140. Network service 120 can provide a service response to client 140 including status information indicating the service request was successful, metadata related to resource 128, information about network service 120, and a representation of resource 128 (e.g., a base64 encoded copy of resource 128) in response to the service request.

Some service responses include parameters provided in service requests. For example, a service request sent by client 140 to network service 120 includes a parameter that is a name or other identifier of a resource. A service response provided to client 140 by network service 120 in response to the service request includes a representation of the resource and the name of the resource. In other words, the parameter from the service request is echoed in the service response.

Service interface analysis system 150 can determine which parameters of service requests are interpreted or used by network service 120 by identifying parameters from service requests that are echoed in service responses. That is, service interface analysis system 150 can assume that parameters from service requests that are echoed in service responses are interpreted by network service 120. Because improper interpretation of parameters at network service 120 can result in security vulnerabilities, service interface analysis system 150 can use this information about which parameters of service requests are interpreted by network service 120 to perform security testing of network service 120.

As specific examples of service requests and service responses, FIGS. 1B and 1D illustrate service requests, according to an implementation. FIGS. 1C and 1E illustrate service responses. Service request 160 illustrated in FIG. 1B is an HTTP GET request and includes portions 161, 162, 163, and 164. Portion 161 identifies the GET HTTP method, a URI (“/PARAMETER1/PARAMETER2/PARAMETER3”), and an identifier of the HTTP version. Portion 162 includes a header with a name/value pair (“HOST” is the name and “WWW.SERVICE.COM” is the value) that identifies the URI of the host (e.g., the network service) to which the service request is provided. Portion 163 is another header with a name/value pair. Portion 164 is an empty line that identifies the end of the service request. Service request 160 includes PARAMETER1, PARAMETER2, and PARAMETER3 at portion 161, and PARAMETER4 at portion 163.

Service response 170 illustrated in FIG. 1C is provided by a network service in response to service request 160. More specifically, service response 170 is formatted according to JavaScript Object Notation (“JSON”), and includes a group of name/value pairs that provide information related to service request 160. Only a few portions of service response 170 specifically applicable to service request 160 are detailed in FIG. 1C. Portion 171 includes the name (“DATA”) of a name/value pair, and the value is an object enclosed by the curly brace symbols (“{” and “}”) at portions 171 and 175. The object (i.e., the value of the name/value pair) includes three name/value pairs. Portion 172 includes the first name/value pair which identifies a data encoding (the name portion is “ENCODING”) with a value of PARAMETER4 from service request 160. Portion 173 includes the second name/value pair which identifies a resource (the name portion is “RESOURCE_NAME”) with a value of PARAMETER3 from service request 160. Portion 174 include the third name/value pair which includes data related to the resource (the name portion is “RESOURCE_DATA”) such as a representation of the resource with a value of “SOME TEXT.” Service interface analysis system 150 can analyze service request 160 and service response 170 to identify parameters PARAMETER3 and PARAMETER4 in each of service request 160 and service response 170, and determine that these parameters are interpreted by network service 120.

Similarly, service request 180 illustrated in FIG. 1D is an HTTP POST request and includes portions 181, 182, 183, 184, 185, 186 and 187. Portion 181 identifies the POST HTTP method, a URI (“/PARAMETER1/PARAMETER2/PARAMETER3”), and an identifier of the HTTP version. Portion 182 includes a header with a name/value pair (“HOST” is the name and “WWW.SERVICE.COM” is the value) that identifies the URI of the host (e.g., the network service) to which the service request is provided. Portion 183 is another header with a name/value pair. Portion 184 is another header with a name/value pair that identifies the content length (“CONTENT-LENGTH” is the name and 21 is the value) of the body portion (here, portion 187) of service request 180. Portion 185 is another header with a name/value pair that identifies the content type (“CONTENT-TYPE” is the name and “APPLICATION/X-WWW-FORM-URLENCODED”is the value) of the body portion. Portion 186 is an empty line that identifies the beginning of the body portion. Portion 187 is a name/value pair with “IDENTIFIER” as the name and “PARAMETER5” as the value). Service request 170 includes PARAMETER1, PARAMETER2, and PARAMETER3 at portion 181, PARAMETER4 at portion 183, and PARAMETER5 at portion 187.

Service response 190 illustrated in FIG. 1E is provided by a network service in response to service request 180. More specifically, service response 190 is a markup language document formatted according to a markup language (e.g., the Extensible Markup Language (XML), and includes a group of elements that provide information related to service request 180. Only a few portions of service response 190 specifically applicable to service request 180 are detailed in FIG. 1E. Portion 191 is an opening tag that identifies the beginning of an element that includes a collection of data, and portion 195 is a closing tag of the element (i.e., portion 195 identifies the end of the collection of data). Portion 192 is an element, identified by an opening tag and a closing tag, that includes PARAMETER3 as a resource name (or identifier). Portion 193 is an element, identified by an opening tag and a closing tag, that includes PARAMETER5 as new data for a resource with PARAMETER3 as a name. Portion 194 is an element, identified by an opening tag and a closing tag, that includes PARAMETER4 as an identifier of a data encoding. In other words, service request 180 provided PARAMETER5 as data encoded in an encoding identified by PARAMETER4 to update (or create) a resource named PARAMETER3, and service response 190 described the results of service request 180.

As discussed above, service interface analysis system 150 can access service requests and service responses. Thus, service interface analysis system 150 can, for example, parse service requests and service responses to identify parameters included in both a service request and a service response. As specific examples, service interface analysis system 150 can parse service requests 160 and 180 and service responses 170 and 190 to identify PARAMETER3 and PARAMETER4 in each of service request 160 and service response 170, and to identify PARAMETER3, PARAMETER4, and PARAMETER5 in each of service request 180 and service response 190. As discussed in more detail herein, service interface analysis system 150 can use this information to perform security testing of network service 120.

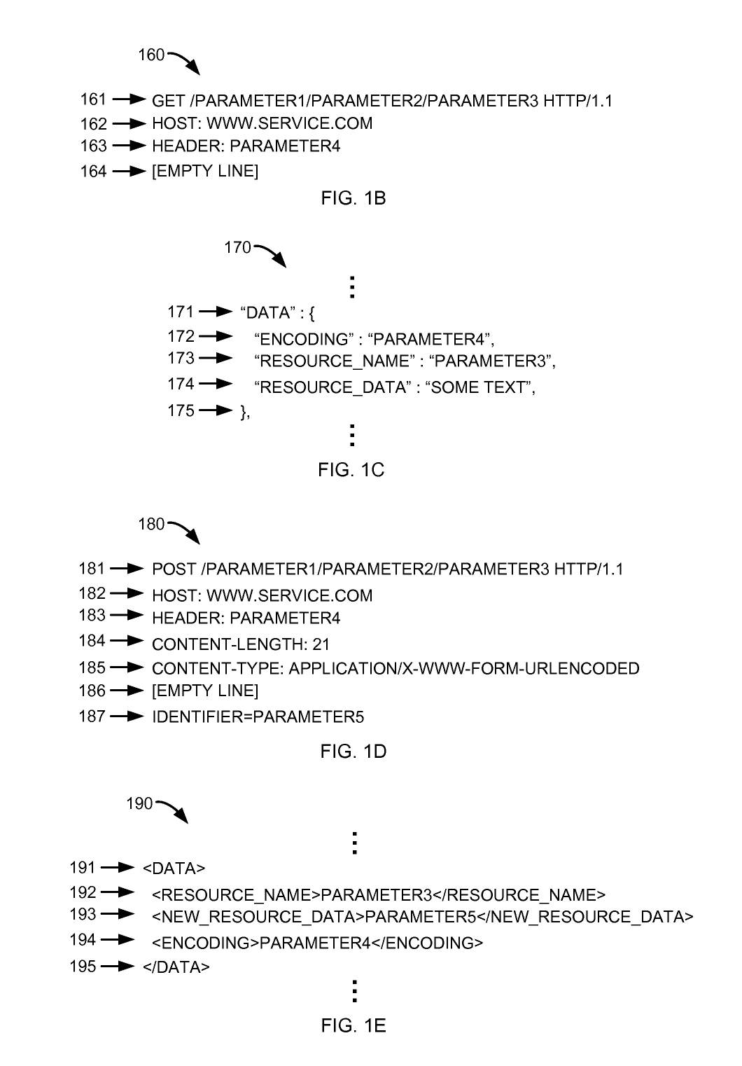

FIG. 2 is a flowchart of a service interface analysis process, according to an implementation. Process 200 can be implemented at a service interface analysis system such as a service interface analysis system hosted at a computing system. Parameters within a service request are identified at block 210. The service request can be accessed according to a variety of methodologies. For example, the service request can be intercepted between a client and a network service. As another example, the service request can be accessed at a data store such as a database including a group of service requests provided by a client to a network service. As yet another example, a service interface analysis system implementing process 200 can generate and provide the service request to a network service.

The parameters within the service request can be identified according to a variety of methodologies. For example, a service interface analysis system implementing process 200 can parse a service request, identify values at various portions of the service request, and store those values at a table or array within a memory. As a specific example, each element of a URI within a service request can be identified as a parameter. As another example, values of name/value pairs at portions of a service request such as header portions or body portions can be identified as parameters. As yet another example, values of name/value pairs at a query string of a URI within a service request can be identified as parameters. Furthermore, values from a body portion of a service request or some other portion or portions of a service request can be stored at a memory as parameters for later analysis of values at various portions of a service response associated with the service request (e.g., a service response generated at a network service in response to the service request).

After parameters are identified a service request at block 210, a service response related to that service request is analyzed at block 220 to determine whether that service response includes any of the parameters. That is, the service response is parsed or searched for parameters that were identified during block 210.

Similar to accessing a service request, a service response can be accessed using a variety of methodologies. For example, the service response can be intercepted between a client and a network service. As another example the service response can be accessed at a data store such as a database including a group of service responses provided by a network service to a client. As yet another example, a service interface analysis system implementing process 200 can receive the service request in response to a service request the interface analysis system provided to the network service.

If, at block 230, no parameter that was included in the service request analyzed at block 210 is included in the service response analyzed at block 220, process 200 returns to block 210 to analyze another service request. If, however, a parameter that was included in the service request analyzed at block 210 is also included in the service response analyzed at block 220, process 200 proceeds to block 240 at which a request template including a placeholder for that parameter is defined (or generated). A request template describes a structure for a service request that conforms to a service interface of a network service, and includes one or more placeholders that identify portions of the request template that are related to portions of that service request that include parameters.

A placeholder is a symbol or group of symbols that identifies a portion of a request template at which values can be substituted to define a service request. For example, a placeholder can be a symbol such as an asterisk character (“*”), a string of the form “{param_<n>}”, where <n> is replaced with an integer for each placeholder identifier, or some other symbol or group of symbols.

In some implementations, a placeholder can be descriptive or include information about the parameter that placeholder replaces (or represents). For example, a placeholder can include a name portion of a name/value pair from a service response with a value portion that includes the parameter the placeholder will replace in a request template. More specifically, referring to FIG. 1C as an example, a placeholder for PARAMETER4 in a request template can be “{ENCODING}”. As another example, a placeholder can include an identifier from a tag of an element that includes a parameter within a markup language document (e.g., an XML document) in a service response. More specifically, referring to FIG. 1E as an example, a placeholder for PARAMETER5 in a request template can be “{NEW_RESOURCE_DATA}”.

As a specific example, referring to service request 160 discussed above in relation to FIGS. 1B and 1D, request template 260 for service request 160 is illustrated in FIG. 2B. Request template 260 is identical to service request 160, except that PARAMETER3 and PARAMETER4 have been replaced with an asterisk character (“*”) as a placeholder. In other words, the parameters of service request 160 that were included in service response 170 have been replaced in request template 260 by placeholders.

In other implementations, a request template can take a different form. For example, a request template can be described by XML elements within an XML document. For example, a service template for service request 160 can be expressed as service request 280 illustrated in FIG. 2C. More specifically, lines 281 and 287 are tags (an opening tag and a closing tag, respectively) that enclose a number of XML elements that describe a request template. Line 282 defines a protocol element for the request template. Line 283 defines a URI element for the request template. The URI represented by the URI element includes a placeholder, here, the asterisk character (“*”). Line 284 defines an XML element that describes the HTTP method of the request template. Line 285 is a host element that describes the host identifier of a network service. Line 286 is a header element that describes a header of a service request. The header element includes a placeholder because a header portion of service request 160 includes a parameter that is also included in service response 170.

After a request template is defined at block 240, process 200 returns to block 210 to analyze another service request. In some implementations, a service interface analysis system implementing process 200 stores the request template at a data store such as a database or a portion of a memory before returning to block 210.

In other implementations, after the service requests and service responses accessible or available to a service interface analysis system implementing process 200 have been analyzed, the service interface analysis system uses request templates to perform security testing on a network service. More specifically, for example, a service interface analysis system can generate service requests from request templates by replacing the placeholders at the service requests with attack data sets. The service interface analysis system can then provide these service requests to the network service and determine, based on service responses from the network service, whether the network service includes security vulnerabilities.

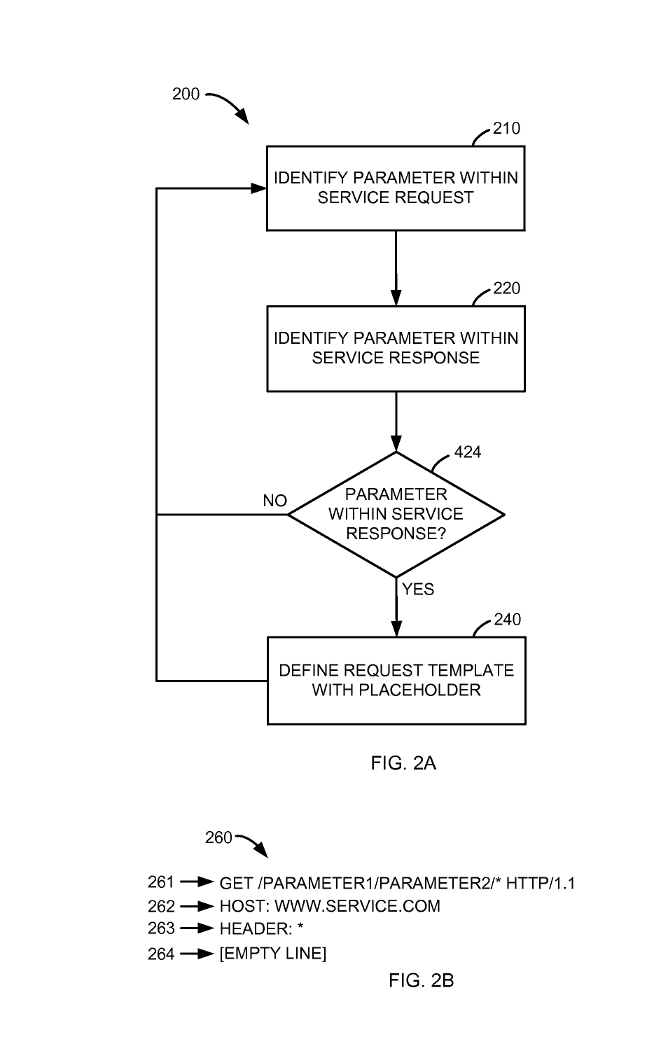

FIG. 3 is data flow diagram illustrating operation of a service interface analysis system, according to an implementation. As discussed above, in some implementations, a service interface analysis system can access service requests and service responses by communicating with a network service (i.e., providing service requests to and receiving service responses from the network service) or by accessing service requests and related service responses at a data store. As illustrated in FIG. 3, service interface analysis system 320 intercepts service requests and service responses exchanged between client 310 and network service 330. In other words, service interface analysis system 320 monitors communication between client 310 and network service 330 to access service requests and related service responses. Said differently, service interface analysis system 320 can identify parameters in service requests and service responses in real-time (i.e., while client 310 and network service 330 communicate the service requests and service responses).

More specifically, service interface analysis system 320 intercepts a service request including a parameter (labeled “PARAM.”) provided to network service 330 by client 310, and identifies the parameter. Network service 330 also receives the service request, processes (or handles) the service request, and provides a service response to client 310. The service response includes the parameter (labeled “PARAM.”) that was included in the service request.

Service interface analysis system 320 intercepts the service response, and identifies the parameter within the service response. Service interface analysis system 320 then defines a request template based on the service request, and inserts a placeholder at a portion of the request template that is related to or represents the portion of the service request that included the parameter. Service interface analysis system 320 then generates a service request based on the request template, and inserts an attack data set at a portion of the generated service request related to the portion of the request template that includes the placeholder.

The attack data set includes a group of symbols to test or probe for a security vulnerability at network service 330 when network service 330 interprets the attack data set. In this example, the generated service request is a copy of the service request provided to network service 330 by client 310 in which the attack data set replaces the parameter. Service interface analysis system 320 then provides the generated service request with the attack data set to network service 330 to determine whether network service 330 includes a security vulnerability related to the attack data set.

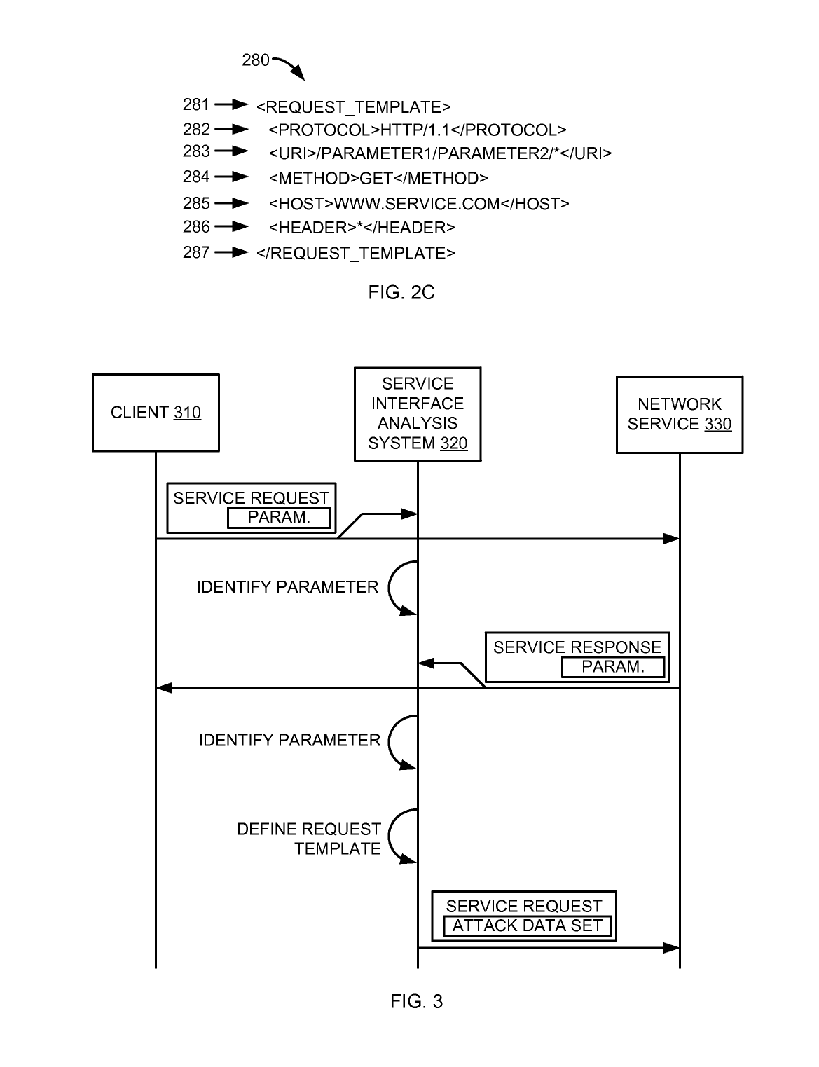

FIG. 4 is an illustration of a service interface analysis process, according to another implementation. Service interface analysis system 400 includes request parser 410, response parser 420, and test module 430. In some implementations, service interface analysis system 400 also includes template module 440 and communications module 450.

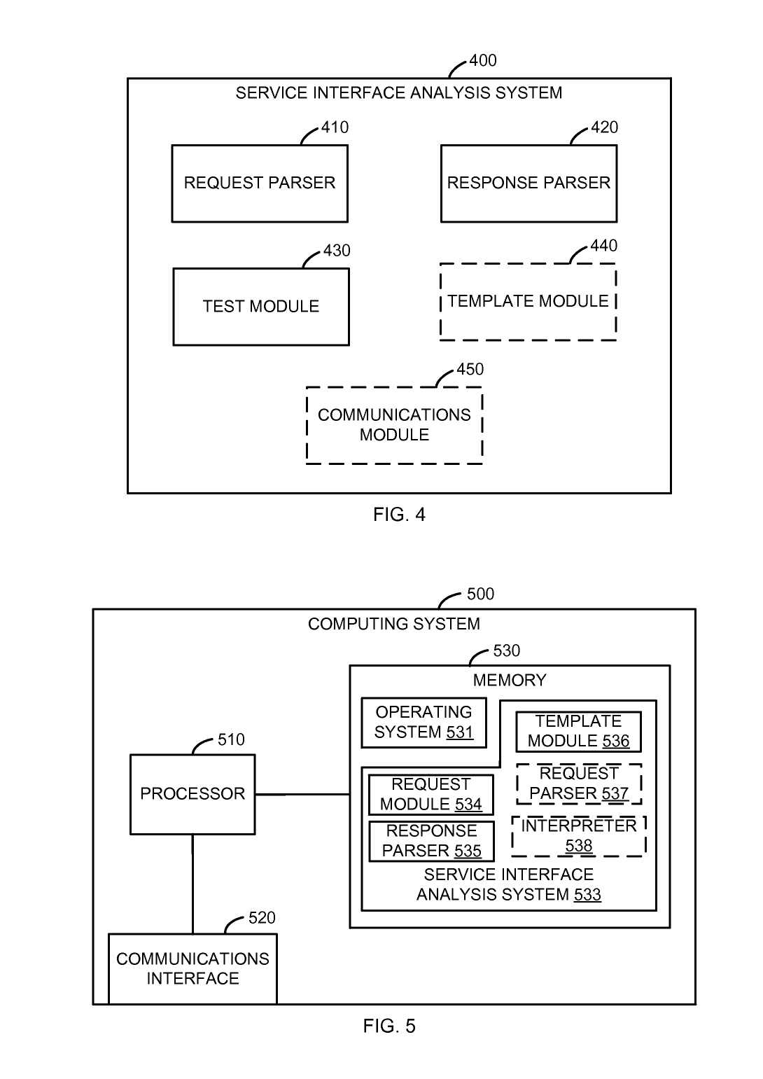

Although various modules (i.e., combinations of hardware and software) are illustrated and discussed in relation to FIGS. 4 and 5 and other example implementations, other combinations or sub-combinations of modules can be included within other implementations. Said differently, although the modules illustrated in FIGS. 4 and 5 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

Request parser 410 is a module (i.e., a combination of hardware and software) that analyzes service requests to identify parameters at portions of the service requests. For example request parser 410 can parse a service request and provide parameters (e.g., symbols or values) included at various portions of the service request to response parser 420. As a specific example, request parser 410 can parse and HTTP service request and store parameters located within a URI portion of the HTTP service request, header portions of the HTTP service request, or a body portion of the HTTP service request at a memory accessible to request parser 410 and response parser 420. Furthermore, in some implementations, request parser 410 can store the service request (or a copy or representation of the service request) at a memory (not shown) for use at, for example, test module 430 or template module 440. Alternatively, for example, request parser 410 can provide the service request to test module 430 or template module 440 directly.

Response parser 420 is a module that analyzes service responses to identify values within the service responses that match parameters that were identified within service requests. In other words, response parser 420 determines whether a service response includes a parameter that was included in a service request for which the service response was generated. Response parser 420 can, for example, parse a service response and compare parameters identified by request parser 410 with values at various portions of the service response. If a parameter matches a value at a portion of the service response, response parser 420 can determine that the service response includes the parameter.

As discussed above, a service response that includes a parameter can be an indication that that parameter is interpreted at a network service. For example, the network service can access the parameter at the service request and perform one or more operations based on the parameter. Accordingly, response parser 420 communicates with test module 430 to indicate to test module 430 which parameters of service requests have been identified in service responses.

Test module 430 is a module that generates service requests based on service requests analyzed at request parser 410. Moreover, test module 430 replaces parameters of service requests identified in those service requests at request parser 410 and in related service responses at response parser 420 with attack data sets. In other words, test module 430 substitutes attack data sets for parameters in the service requests generated at test module 430.

Test module 430 then provides the service requests to a network service and analyzes one or more service responses to determine whether a security vulnerability for the attack data set exists or is expose at the network service. In some implementations, test module 430 generates a group of service requests, each with a different attack data set intended to test for a particular security vulnerability from a group of security vulnerabilities, and provides the group of service requests to the network service to determine whether any of the group of security vulnerabilities exists or is exposed at the network service.

In some implementations, test module 430 generates service requests based on request templates generated at template module 440. Template module 440 is a module that receives or accesses service requests (e.g., provided by request parsers 410 after request parser 410 analyzes the service requests) and defines request templates based on those service requests. More specifically, template module 440 can communicate with response parser 420 to receive an indication of which parameter or parameters of a service request were included in a service response for that service request (e.g., a service response provided by a network service in response to the service request). Template module 440 can then define a request template in which that parameter (or those parameters) is replaced by a placeholder.

Moreover, template module 440 can provide the request templates to test module 430, and test module 430 can generate service requests by replacing the placeholders in the request templates with attack data sets. In other words, the request templates describe the structure of service requests and identify portions of those service requests that include parameters that are interpreted at a network service. Test module 430 injects attack data sets into service requests by generating those service requests according to (or based on) one or more request templates, and including the attack data sets at portions of those service requests that correspond to portions of the one or more request templates that include a placeholder.

Furthermore, service interface analysis system 400 can include communications module 450. Communications module 450 is a module such as a communications interface via which service interface analysis system 400 can communicate with other systems such as computing systems hosting a client or a network service. In other words, service interface analysis system 400 can access (e.g., receive) service requests and service responses via communications module 450, and can provide service requests (e.g., generated at test module 430) via communications module 450.

FIG. 5 is a schematic block diagram of a service interface analysis system hosted at a computing system, according to an implementation. In the example illustrated in FIG. 5, computing system 500 includes processor 510, communications interface 520, and memory 530; and hosts operating system 531 and service interface analysis system 533. Service interface analysis system 533 includes a group of components including request module 534, response parser 535, and template module 536. In some implementations, service interface analysis system 533 includes request parser 537 and interpreter 538.

Request module 534 is a module that provides service requests that include one or more parameters to a network service. The service requests can be provided to the network service via, for example, communications interface 520. Service responses to the service requests are received at response parser 535, for example, via communications interface 520, and response parsers 535 analyzes the service responses to identify parameters included in the service requests. In other words, response parser 535 is similar to response parser 420 discussed above in relation to FIG. 4. Moreover, similar to the discussion above in relation to FIG. 4, template module 536 generates request templates based on the service requests provided to the network service by request module 534 and indications of which portions of those service requests include parameters that are interpreted by the network service (e.g., parameters that were identified at service responses related to the service requests that included those parameters).

In some implementations, service interface analysis system 533 includes request parser 537. Request parser 537 is similar to request parser 410 discussed above in relation to FIG. 4, and parses service requests provided by request module 534 to the network service to identify parameters within those service requests. Moreover, request parser 537 can provide those parameters or representations of those parameters to response parser 535.

Additionally, as illustrated in FIG. 5, in some implementations, service interface analysis system 533 includes interpreter 538. Interpreter 538 identifies the service requests that request module 534 provides to the network service. For example, interpreter 538 can scan or crawl various web pages or other documents to identify service requests (e.g., HTTP GET or POST requests). As another example, such documents can include code or instructions such as JavaScript™ that generate service requests. Interpreter 538 can identify and execute such code or instructions to generate one or more service requests. As a specific example, the code or instructions can define a JavaScript™ function. Interpreter 538 can provide one or more arguments (if required by the function) in a call to the function, and can intercept the output of the function to generate a service request. The service request can then be analyzed by request parser 537 to identify parameters within the service request, and provided to a network service by request module 534.

Processor 510 is any combination of hardware and software that executes or interprets instructions, codes, or signals. For example, processor 510 can be a microprocessor, an application-specific integrated circuit (ASIC), a distributed processor such as a cluster or network of processors or computing systems, a multi-core or multi-processor processor, or a virtual or logical processor of a virtual machine.

Communications interface 520 is a module via which processor 510 can communicate with other processors or computing systems via a communications link. For example, communications interface 520 can include a network interface card and a communications protocol stack hosted at processor 510 (e.g., instructions or code stored at memory 530 and executed or interpreted at processor 510 to implement a network protocol) to communicate network services. As specific examples, communications interface 520 can be a wired interface, a wireless interface, an Ethernet interface, a Fiber Channel interface, an InfiniBand interface, and IEEE 802.11 interface, or some other communications interface via which processor 510 can exchange signals or symbols representing data to communicate with other processors or computing systems.

Memory 530 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 530 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 530 can represented multiple processor-readable media. In some implementations, memory 530 can be integrated with processor 510, separate from processor 510, or external to computing system 500.

Memory 530 includes instructions or codes that when executed at processor 510 implement operating system 531 and service interface analysis system 533 (and the components or modules of service interface analysis system 533). Said differently, service interface analysis system 533, or the modules that define service interface analysis system 533, is hosted at computing system 500.

In some implementations, computing system 500 can be a virtualized computing system. For example, computing system 500 can be hosted as a virtual machine at a computing server. Moreover, in some implementations, computing system 500 can be a virtualized computing appliance, and operating system 531 is a minimal or just-enough operating system to support (e.g., provide services such as a communications protocol stack and access to components of computing system 500 such as communications interface 520) service interface analysis system 533.

Service interface analysis system 533 can be accessed or installed at computing system 500 from a variety of memories or processor-readable media. For example, computing system 500 can access service interface analysis system 533 at a remote processor-readable medium via communications interface 520. As a specific example, computing system 500 can be a thin client that accesses operating system 653131 and service interface analysis system 533 during a boot sequence.

As another example, computing system 500 can include (not illustrated in FIG. 5) a processor-readable medium access device (e.g., CD, DVD, SD, MMC, or a CF drive or reader), and can access service interface analysis system 533 at a processor-readable medium via that processor-readable medium access device. As a more specific example, the processor-readable medium access device can be a DVD drive at which a DVD including an installation package for service interface analysis system 533 is accessible. The installation package can be executed or interpreted at processor 510 to install service interface analysis system 533 at computing system 500 (e.g., at memory 530). Computing system 500 can then host or execute service interface analysis system 533.

In some implementations, service interface analysis system 533 can be accessed at or installed from multiple sources, locations, or resources. For example, some component of service interface analysis system 533 can be installed via a communications link, and other components of service interface analysis system 533 can be installed from a DVD.

In other implementations, service interface analysis system 533 can be distributed across multiple computing systems. That is, some components of service interface analysis system 533 can be hosted at one computing system and other components of service interface analysis system 533 can be hosted at another computing system or computing systems. As a specific example, service interface analysis system 533 can be hosted within a cluster of computing systems where each component of service interface analysis system 533 is hosted at multiple computing systems, and no single computing system hosts each component of service interface analysis system 533.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data via a communications path or channel), pull mechanisms (e.g., delivering data in response to a request), and store mechanisms (e.g., storing data at a data store or service at which the data can be accessed). Furthermore, as used herein, the term “based on” includes based at least in part on. Thus, a feature that is described as based on some cause, stimulus, or data; can be based only on that cause, stimulus, or data; or based on that cause, stimulus, or data and on one or more other causes, stimuli, or data.

What is claimed is:

1. A processor-readable medium, comprising code representing instructions that when executed at a processor cause the processor to:
identify a parameter at a portion of a service request for a network service;
identify the parameter within a service response provided by the network service in response to the service request; and
define a request template including a placeholder at a portion of the request template associated with the portion of the service request.

2. The processor-readable medium of claim 1, wherein the service request is a first service request, further comprising code representing instructions that when executed at the processor cause the processor to:
generating a second service request based on the request template, the second service request including an attack data set in a portion of the second service request associated with the portion of the request template including the placeholder.

3. The processor-readable medium of claim 1, further comprising code representing instructions that when executed at the processor cause the processor to:
provide the service request to the network service; and
receive the service response from the network service.

4. The processor-readable medium of claim 1, further comprising code representing instructions that when executed at the processor cause the processor to:
intercept the service request; and
intercept the service response.

5. The processor-readable medium of claim 1, further comprising code representing instructions that when executed at the processor cause the processor to:
access the service request and the service response at a data store.

6. The processor-readable medium of claim 1, wherein:
the parameter is included within the service response at a value portion of a name/value pair; and
the placeholder includes an identifier based on a name portion of the name/value pair.

7. The processor-readable medium of claim 1, wherein:
the parameter is included within the service response at an element of markup language document; and
the placeholder includes an identifier based on a tag of the element.

8. The processor-readable medium of claim 1, wherein the portion of the service request is one of a Uniform Resource Identifier of the service request, a header of the service request, or a body of the service request.

9. A service interface analysis system, comprising a processor-readable medium encoded with code representing instructions that when executed cause a processor to implement a service interface analysis system, the service interface analysis system including:
a request module to provide a service request to a network service, a portion of the service request including a parameter;
a response parser to determine whether the parameter is included within a service response associated with the service request; and
a template module to define a request template including a placeholder at a portion of the request template associated with the portion of the service request.

10. The system of claim 9, wherein the service interface analysis system further includes a request parser to identify the parameter at the portion of the service request.

11. The system of claim 9, wherein the service interface analysis system further includes a request parser to identify a plurality of parameters within the service request, the parameter at the portion of the service request being one of the plurality of parameters.

12. The system of claim 9, wherein the service interface analysis system further includes an interpreter to identify a plurality of service requests, the service request being one of the plurality of service requests.

13. A service interface analysis system, comprising:
a request parser to identify a parameter at a portion of a first service request;
a response parser to determine whether the parameter is included within a service response associated with the first service request; and
a test module to generate a second service request based on the first service request, the second service request including an attack data set at a portion of the second service request associated with the portion of the first service request.

14. The system of claim 13, further comprising:
a template module to define a request template including a placeholder at a portion of the request template associated with the portion of the first service request.

15. The system of claim 13, further comprising:
a communications module to provide the first service request and the second service request to the network service and to receive the service response.

16. The system of claim 13, further comprising:
a communications module to receive the first service request and the service response.
